(19) United States
(12) Patent Application Publication
(10) Pub. No.: US 2020/0374079 A1
(43) Pub. Date: Nov. 26, 2020

(54) SINGLE TAP AND SINGLE FREQUENCY NETWORK (SFN) HIGH-SPEED TRAIN (HST) TECHNOLOGIES

(71) Applicants: Andrey Chervyakov, Nizhny Novgorod (RU); Dmitry Belov, Nizhny Novgorod (RU); Artyom Putilin, Kstovo (RU); Alexey Khoryaev, Nizhny Novgorod (RU); Manasa Raghavan, Sunnyvale, CA (US)

(72) Inventors: Andrey Chervyakov, Nizhny Novgorod (RU); Dmitry Belov, Nizhny Novgorod (RU); Artyom Putilin, Kstovo (RU); Alexey Khoryaev, Nizhny Novgorod (RU); Manasa Raghavan, Sunnyvale, CA (US)

(21) Appl. No.: 16/993,901

(22) Filed: Aug. 14, 2020

Related U.S. Application Data
(60) Provisional application No. 62/887,541, filed on Aug. 15, 2019.
(60) Provisional application No. 62/887,543, filed on Aug. 15, 2019.

(51) Int. Cl. H04L 5/00; H04W 72/04; H04L 27/26; H04W 76/27; H04W 24/10

(52) U.S. Cl. CPC H04L 5/0048; H04W 72/042; H04L 27/2657; H04W 76/27; H04W 24/10; H04L 27/2613

(57) ABSTRACT

An apparatus for use in a UE includes processing circuitry coupled to a memory. To configure the UE for high-speed train (HST) communications in a 5G-NR network, the processing circuitry is to decode configuration signaling received from an RRH operating as a gNB. The configuration signaling indicating an upcoming configuration transmission of network assistance information from the RRH. The network assistance information received from the RRH is decoded. TRS-based processing is performed to track a frequency offset (FO) associated with a downlink data transmission from the RRH. The TRS-based processing using a single-shot FO estimation based on a FO instruction in the network assistance information received from the RRH. The downlink data transmission is demodulated based on applying a local oscillator (LO) adjustment using the FO.

### PRIORITY CLAIM

This application claims the benefit of priority to the following provisional applications:

U.S. Provisional Patent Application Ser. No. 62/887,541, filed Aug. 15, 2019, and entitled “SINGLE TAP HIGH-SPEED TRAIN SCENARIO TECHNOLOGIES”; and

U.S. Provisional Patent Application Ser. No. 62/887,543, filed Aug. 15, 2019, and entitled “HIGH-SPEED TRAIN SFN SCENARIOS.”

Each of the provisional patent application identified above is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks such as 5GNR unlicensed spectrum (NR-U) networks. Other aspects are directed to systems and methods for single tap and single frequency network (SFN) high-speed train (HST) technologies.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE systems in the licensed as well as unlicensed spectrum is expected in future releases and 5G systems. Such enhanced operations can include techniques for single tap and SFN HST technologies.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2 illustrates a single tap HST deployment, in an example embodiment.

FIG. 3 illustrates frequency shift variation for a single tap HST model, in an example embodiment.

FIG. 4 illustrates a graph of the difference between estimated and actual Doppler frequency value, in an example embodiment.

FIG. 5 illustrates graphs of residual frequency offset error, in an example embodiment.

FIG. 6 illustrates network assistance and UE behavior, in an example embodiment.

FIG. 7 illustrates gNB signaling to adjust the UE uplink (UL) transmission frequency, in an example embodiment.

FIG. 8 illustrates LTE multi-RRH HST-SFN deployment, in an example embodiment.

FIG. 9 illustrates SFN and non-SFN transmissions associated with different TCI states, in an example embodiment.

FIG. 10 illustrates non-SFN reference signal (RS) transmissions, in an example embodiment.

FIG. 11 illustrates a block diagram of a communication device such as an evolved Node-B (eNB), a new generation Node-B (gNB), an access point (AP), a wireless station (STA), a mobile station (MS), or user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

FIG. TA illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

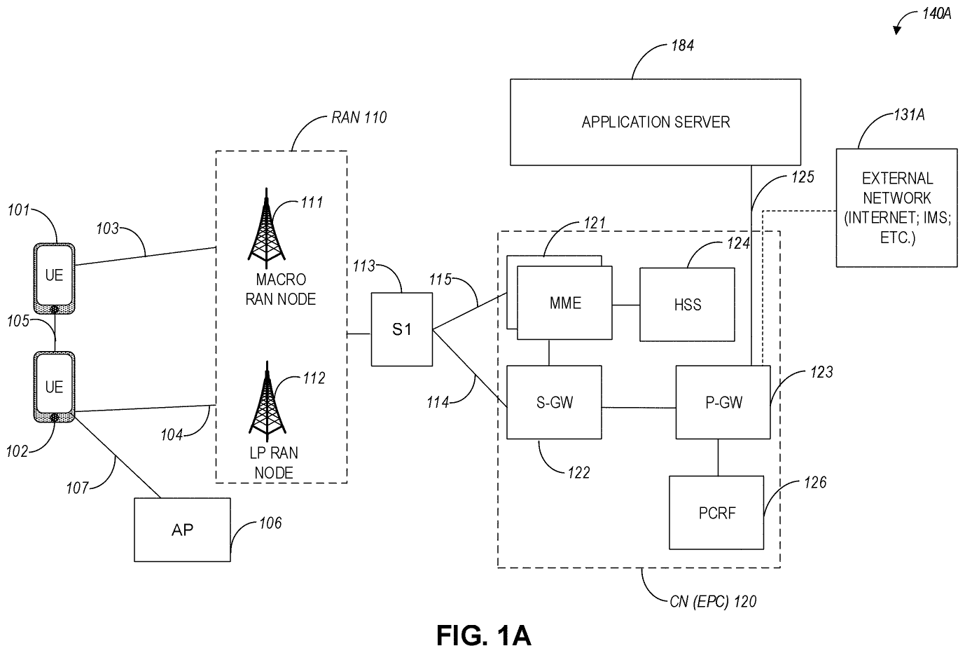

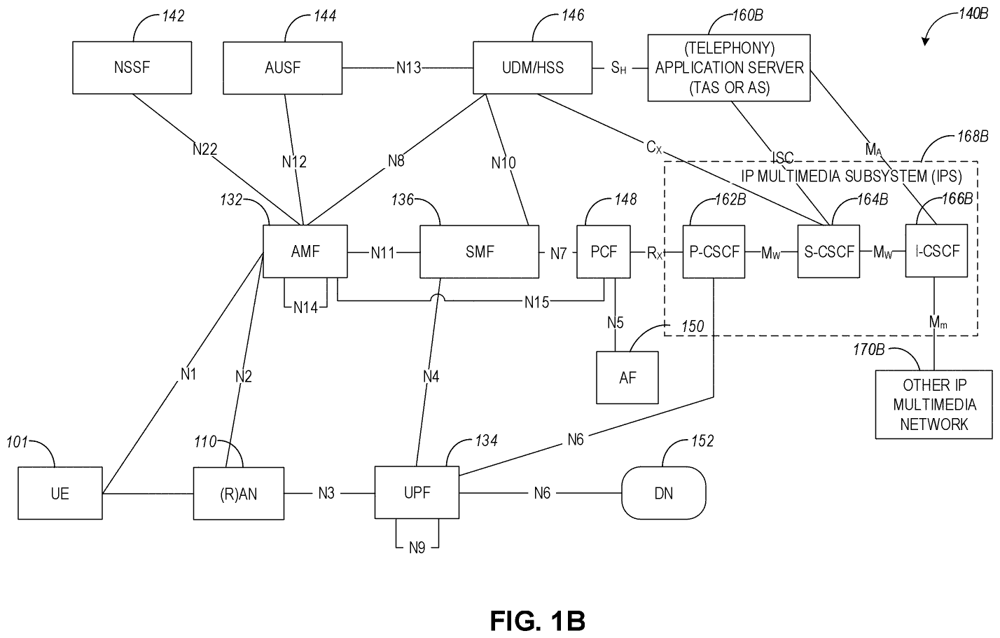

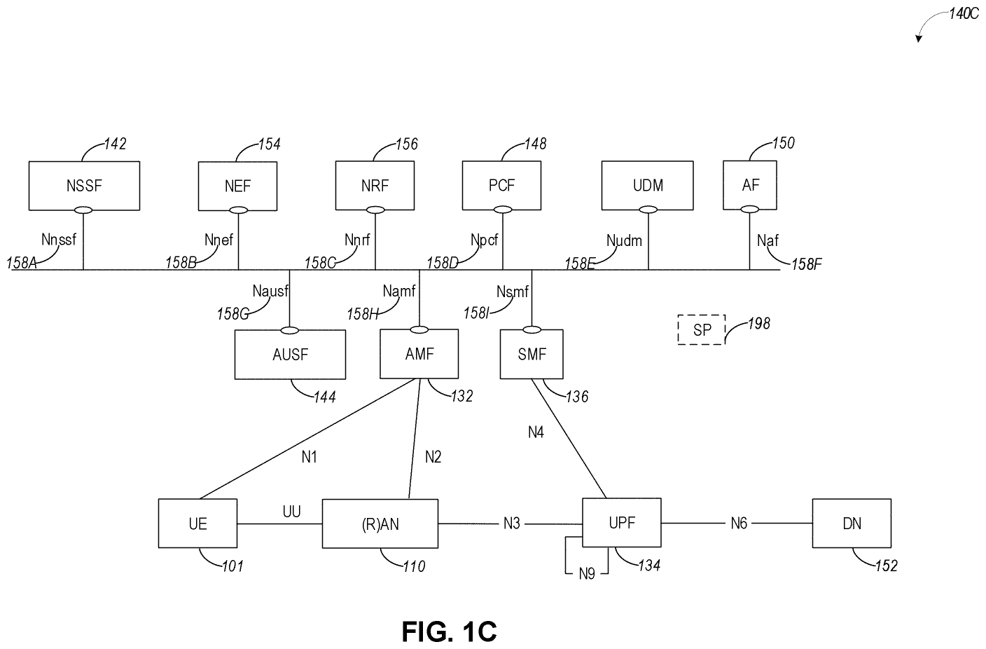

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1E can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

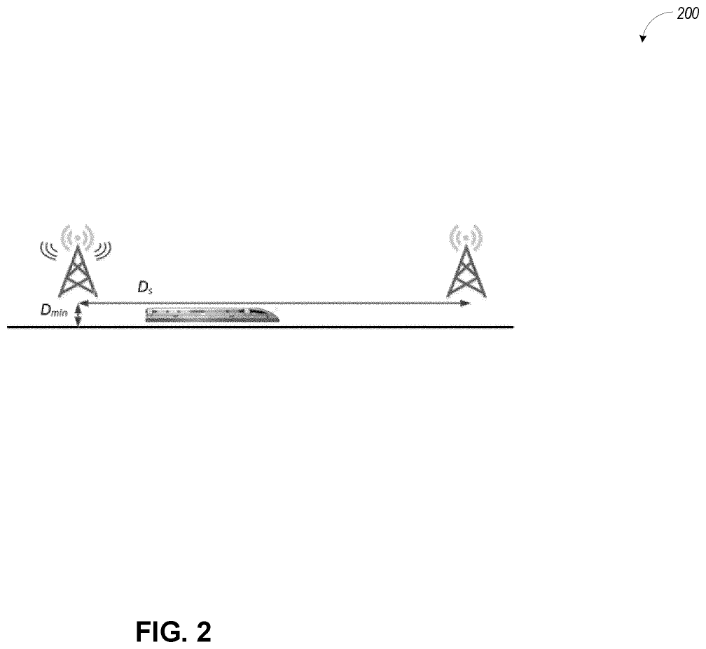

In example embodiments, any of the UEs or base stations discussed in connection with FIG. 1A-FIG. 1C can be configured to operate using the techniques discussed in connection with FIG. 2-FIG. 11.

IMT-2020 is expected to enable high mobility with up to 500 km/h with acceptable QoS and a high-speed train (HST) scenario is considered as one of the baseline deployment scenarios for NR technology and captured in NR study item TR 38.913 (V15.0.0; 2018-06).

Under HST conditions, it is expected that the Doppler shift and Doppler spread will be severe (e.g. for 500 km/h with 3.6 GHz carrier frequency, the Doppler shift will be about 1.66 kHz) and hence it can be challenging to ensure reliable performance. The baseline Rel-15 NR UE performance requirements do not guarantee proper UE performance under such conditions. Therefore, to ensure a consistent NR performance under HST conditions, a new 3GPP RAN4-led work item (WI) on high-speed train performance requirements was initiated in June 2019. This new WI is aimed to specify NR UE demodulation requirements, BS demodulation requirements, and radio resource management (RRM) requirements for the HST scenario with up to 500 km/h. The detailed WI objectives are as follows:

Objective of SI or Core Part WI or Testing Part WI

Investigate and specify the following scenarios: NR SA single carrier scenario. Study the EN-DC scenario considering the LTE HST performance. The channel model: HST-SFN scenarios, i.e. multiple RRHs connecting to one BBU. The channel model for HST-SFN will be discussed in this WI; HST single tap channel model; Other channel models are not precluded.

The maximum Doppler frequency will be investigated and determined based on operating frequency, velocity, and NR design limitations for all UL/DL physical channels. The carrier frequency is up to 3.6 GHz covering both TDD and FDD. The feasibility of supporting speeds of up to a maximum of 500 km/h will be investigated. The actual maximum supported velocity at 3.6 GHz will be decided in this WI.

Investigate and specify the UE RRM core requirements for Idle and inactive mode: Cell reselection including cell identification and measurement requirements. Connected mode: Cell identification requirements; Measurement delay requirements; Study whether to introduce beam management-related requirements, e.g. L1-RSRP measurement; Study the impact on RLM and UL timing.

Objective of Performance Part WI

Investigate and specify the RRM performance requirements of measurement accuracy.

Specify the RRM test cases related to new core requirements (if defined): Idle and inactive mode—Cell reselection including cell identification and measurement requirements; Connected mode: Cell identification requirements; Measurement delay requirements; Measurement accuracy requirements.

Other test cases are not precluded if the core requirements are defined, e.g. beam management, RLM, UL timing, etc.

Specify the UE demodulation requirements and test cases for NR PDSCH. Other requirements are not precluded if needed.

Specify the BS demodulation requirements and test cases for PUSCH. PRACH restricted set A for preamble format 0. PRACH restricted set B for preamble format 0. PUSCH for UL timing adjustment. Other requirements are not precluded if needed.

Techniques disclosed herein can be used for configuring single tap HST scenarios and deployments.

Single Tap HST Model

FIG. 2 illustrates a diagram 200 of a single tap HST deployment, in an example embodiment.

The single tap HST channel model is used for the definition of LTE Rel-8 and NR Rel-15 requirements for HST deployment. The single tap scenario corresponds to a general HST deployment which includes multiple remote radio heads (RRHs) deployed across the railways. In contrast to HST-SFN deployments, the single tap scenario characterizes the case when RRHs perform non-SFN transmissions to the UEs. Single tap HST deployment is characterized by the distance between RRHs (gNB) Ds and distance to a railway track Dmin, as illustrated in FIG. 2.

Table 1 provides information about values for these parameters which are used for NR Rel-15 requirements, as defined in TS 38.101-4 Annex B.3:

TABLE 1

| Parameter | Value, m |
|---|---|
| D_{S} | 300 |
| Dₘᵢₙ | 2 |

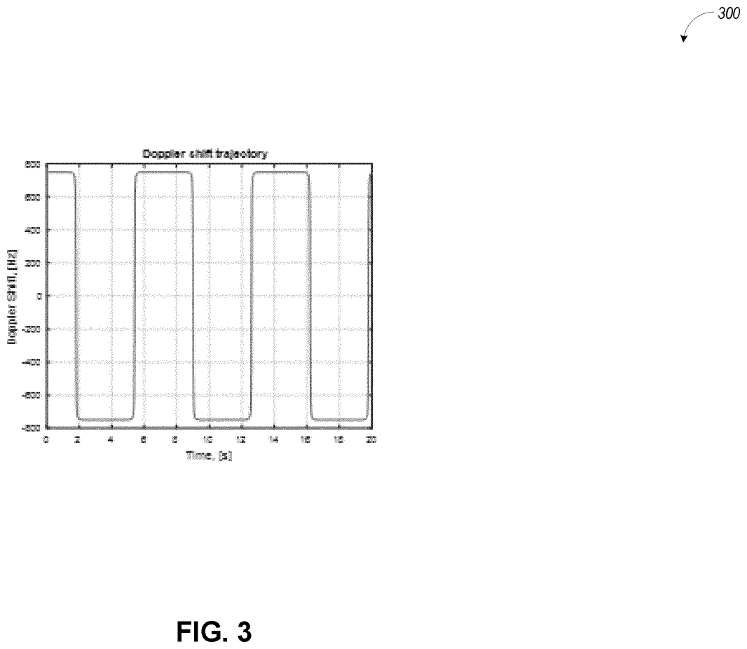

FIG. 3 illustrates a graph 300 of frequency shift variation for a single tap HST model, in an example embodiment. More specifically, FIG. 3 illustrates Doppler shift variation for a single tap channel model with 300 km/h train speed and 2.7 GHz carrier frequency. It can be observed that the deployment is characterized by a unique Doppler shift trajectory and the RX Doppler shift changes from positive values to negative values as UE moves along the railways.

The main purpose of the PDSCH demodulation test under the HST single tap scenario is to ensure that UE can handle high Doppler shift values and track fast variations of Doppler shift from positive to a negative value.

Rel-15 NR HST requirements are defined under 300 km/h train speed conditions. For 15 kHz SCS requirements a 2.7 GHz carrier frequency was assumed which corresponds to 750 Hz maximum Doppler shift. For 30 kHz SCS requirements a 3.6 GHz carrier frequency was assumed which corresponds to 1000 Hz maximum Doppler shift.

In Rel-16 NR HST WI, the maximum considered Doppler frequency is expected to be limited by 1666 Hz which corresponds to the 3.6 GHz carrier frequency and 500 km/h train speed. Same time the NR HST WID does not provide the exact Doppler frequency to be used to define the requirements and RAN4 shall investigate the maximum Doppler frequency taking into account the NR design limitations for all UL/DL physical channels. In general, the maximum supported Doppler frequency depends on both DL and UL performance and it may be not reasonable to introduce tight DL requirements along with loose UL requirements and vice versa.

Frequency Error Model

In the case of a single tap channel model, the downlink (DL) and uplink (UL) receive (RX) signals will include the Doppler shift which will affect the frequency error models for the DL and UL signals. At the UE side, it is not possible to completely differentiate the RX local oscillator (LO) frequency error and receive signal Doppler shift (FDoppler). Hence, UE will adjust its RF chains to match the carrier frequency of the RX signal.

The following generic DL/UL frequency error model can be assumed:

gNB TX/RX carrier frequency FgNB can be expressed as follows: FgNB=FC+ΔFgNB, where Fc is the ideal TX/RX carrier frequency, and ΔFgNB is base station (BS) TX carrier frequency error (e.g. ±0.05 ppm).

The DL TX signal frequency (FDL_TX) is the same as the gNB TX carrier frequency (under assumption that UE does not apply any carrier frequency pre-compensation) FDL_TX=FgNB=FC+ΔFgNB.

The DL RX signal frequency at the UE side (FDL_RX) will include additional frequency offset due to Doppler shift (FDoppler) relative to the gNB transmit frequency: FDL_RX=FDL_TX+FDoppler=FC+ΔFgNB+FDoppler with FDoppler=v/c*FgNB, where v is the UE speed relative to the gNB. The UE TX/RX carrier frequency F_{UE} will be adjusted to the DL RX signal frequency and can be derived as F_{UE}=FDL_RX+ΔF_{UE}=FC+ΔFgNB+FDoppler+ΔF_{UE}, where ΔF_{UE} is UE TX carrier frequency error which comes due to imperfect frequency tracking. In the general case, the error is typically bounded by 0.1 ppm but this may not necessarily hold for the HST single tap scenario (e.g. in case UE is not provided with sufficient reference signals (RS) for frequency offset (FO) tracking). The above is based on an assumption that the UE cannot differentiate LO frequency errors/fluctuations and the effective Doppler shift and the AFC scheme will handle a combined effect and tune the TX/RX LO oscillator with respect to the effective DL RX signal frequency.

The effective residual frequency error for DL reception at the UE side ΔFDL can be expressed as follows: ΔFDL=FDL_RX−F_{UE}=ΔF_{UE}.

The UL TX signal frequency (FUL_TX) is same the UE TX/RX carrier frequency is FUL_TX=F_{UE}=FC+ΔFgNB+FDoppler+ΔF_{UE}.

The UL RX signal frequency at the gNB side (FUL_RX) will include additional frequency offset due to the Doppler shift (FDoppler) relative to the UL transmit frequency and is expressed as FUL_RX=FUL_TX+FDoppler=FC+ΔFgNB+FDoppler+ΔF_{UE}+FDoppler.

The effective residual frequency error for UL reception at the gNB side ΔFUL can be expressed as follows: ΔFUL=FUL_RX−FgNB=2FDoppler+ΔF_{UE}.

Based on the analysis above we can make the following observations on the frequency error models. The DL frequency error can be represented as “ΔF_{UE}”, where ΔF_{UE} is the UE frequency tracking error. The UL frequency error can be represented as “2·FDoppler+ΔF_{UE}”, where FDoppler is the Doppler shift due to propagation through a single tap HST channel and ΔF_{UE} is the UE frequency tracking error.

The following technical configurations are expected to be observed in the single tap HST scenarios:

Issue #1 (DL Performance)

In the single tap HST scenarios, a typical UE implementation is expected to perform continuous FO tracking and apply LO adjustment to match the RX signal carrier frequency. The RX signal FO observed at the RX side includes the Doppler shift as well as LO frequency error (e.g. due to drift). In general, different RS can be used for FO tracking including TRS (CSI-RS for tracking), PDSCH DMRS, and SS/PBCH.

SS/PBCH are typically applied for coarse frequency tracking and further fine adjustment is assumed to be done based on TRS signals. CSI-RS for tracking (also known as TRS) is dedicated reference signals which were introduced for tracking of different parameters of propagation conditions. Also, PDSCH DMRS based estimation can be used to improve accuracy. However, PDSCH transmission in each slot is not guaranteed and, hence, it is reasonable to assume that SS/PBCH and TRS FO tracking are used as baseline methods.

The maximum frequency error which can be handled/estimated using TRS is limited by the subcarrier spacing. In Table 2, the theoretical limits of maximum estimated frequency offset for TRS are presented.

TABLE 2

| | SCS | | |
|---|---|---|---|
| RS | 15 kHz | 30 kHz | 60 kHz |
| TRS | 1750 Hz | 3500 Hz | 7000 Hz |

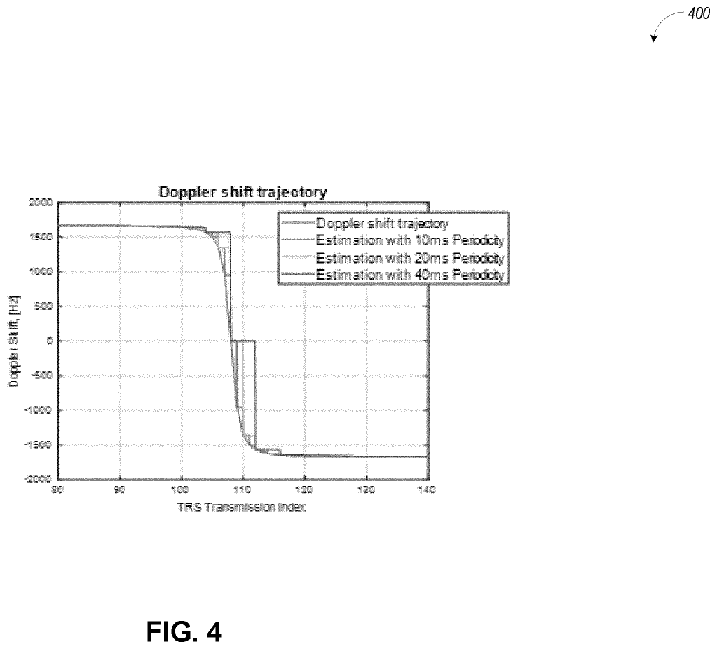

FIG. 4 illustrates a graph 400 of the difference between estimated and actual Doppler frequency value, in an example embodiment.

Single tap HST channel model has a specific Doppler shift trajectory and has regions with a fast change of Doppler frequency from positive to a negative value and vice versa (“slope” regions). Tracking reference signals (TRS) have at least 10 ms transmission periodicity and, hence, TRS based FO tracking will result in systematic residual FO estimation errors in the slots between the consecutive TRS transmissions. In FIG. 4, the difference between Doppler frequency, assumed at the receiver side, after TRS based estimation, and actual Doppler frequency for different TRS periodicity is illustrated. In FIG. 4, residual frequency error in case of using TRS tracking is also illustrated. The results on the left figure are provided for the case single-shot processing (i.e. no averaging/filtering of FO estimates over different TRS occasions) and for the case of different TRS transmission periodicities. The results on the right figure are shown for the case two-shot TRS processing (i.e., FO averaging over 2 consecutive TRS occasions).

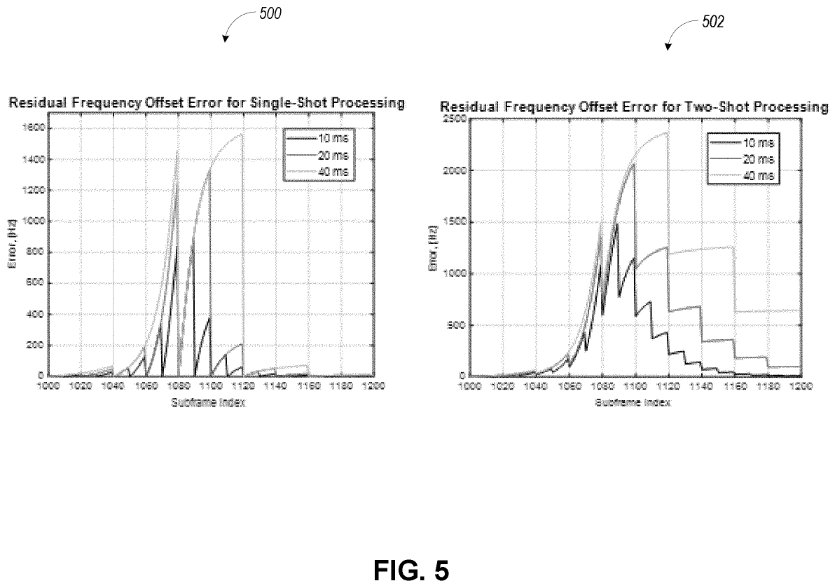

FIG. 5 illustrates graphs 500 and 502 of residual frequency offset error, in an example embodiment.

Based on the above evaluations, the maximum residual FO is 880, 1320, and 1560 Hz for the case of 10 ms, 20 ms, and 40 ms TRS periodicity for single-shot TRS processing (as seen in FIG. 5). The max residual FO can further increase in the case of certain filtering for FO estimates across multiple samples. For example, for two-shot processing error can be up to 1480, 2060, and 2365 Hz depending on TRS periodicity.

Taking into account that the UE is not aware of whether it works in a single tap HST deployment or a general (non-HST) deployment, we cannot guarantee that UE does not make TRS filtering which can degrade performance in HST deployment. Therefore, under single tap HST conditions, such implementations may experience certain performance degradation and certain solutions shall be considered to solve it.

Issue #2 (UL Performance)

In single tap deployment, the UE is expected to adjust its TX frequency to the effective receive signal frequency which includes the Doppler shift (FDoppler). Therefore, at the gNB RX side, the total frequency offset may increase significantly and can exceed 2× FDoppler. The Doppler frequency component is equal to 1666 Hz for the case of 3.6 GHz carrier frequency and 500 km/h speed. Therefore, the total frequency offset upper bound is equal to at least 3.3 kHz.

For UL demodulation, it is reasonable to assume that the gNB may receive signals from multiple UEs simultaneously and, hence, the gNB may have limited capabilities to perform pre-FFT FO adjustment for each UE. Hence, it may be assumed that gNB may track the frequency offset of each UE using PUSCH DMRS on a per-slot basis and apply a post-FFT FO compensation as a part of PUSCH demodulation. In Table 3, there is presented a maximum theoretical limit of estimated frequency offset using PUSCH DMRS.

TABLE 3

| | SCS | | |
|---|---|---|---|
| RS | 15 kHz | 30 kHz | 60 kHz |
| PUSCH with 3 add. | 2333 Hz | 4666 Hz | 9333 Hz |
| DMRS | | | |
| PUSCH with 2 add. | 1750 Hz | 3500 Hz | 7000 Hz |
| DMRS | | | |
| PUSCH with 1 add. | 875 Hz | 1750 Hz | 3500 Hz |
| DMRS | | | |

Observation: Due to limitations on the maximum handled estimated frequency offset in UL. For scenarios with 15 kHz: the system cannot work in scenarios with 3.6 GHz carrier frequency and 500 km/h speed (i.e. Doppler shift 3.3 kHz). Maximum theoretical supported Doppler shift in one direction (UL or DL) for scenarios with 15 kHz SCS is about 1000 Hz (taking into account UE frequency tracking error).

For scenarios with 30 kHz: scenarios with 3.6 GHz carrier frequency and 500 km/h speed potentially can be handled only in case PUSCH with 3 additional DMRS is configured.

In a general case, it may not be reasonable to define DL demodulation requirements to support 500 km/h+3.6 GHz carrier frequency (i.e. 1.6 kHz Doppler shift) in case the corresponding scenario cannot be supported in UL the direction. Therefore, certain solutions to avoid large FO are needed.

Techniques discussed herein may be used to support the following embodiments. Embodiment #1: Averaging over multiple TRS estimates may result in substantial frequency offset (FO) estimation errors in HST deployments at the UE side, which may result in performance degradation. The UE may not be able to operate in high-speed train deployments, especially for 15 kHz SCS. Embodiment #2: In legacy solutions, the BS may experience high ICI, which may harm the overall performance. Also, the BS may not be able to support high-speed operation under 15 kHz scenarios.

### Embodiment #1: Network Assistance for Single Tap HST Scenarios

The embodiment #1 is aimed to solve Issue #1 described above. In the single tap HST scenarios, a typical UE implementation is expected to perform continuous FO tracking and apply LO adjustment to match the RX signal carrier frequency. RX FO tracking is typically based on a tracking reference signal (TRS) (CSI-RS for tracking). The TRS has quite a sparse transmission periodicity (min 10 ms) and due to fast change of the Doppler UE may not be able to precisely follow the channel Doppler variation which can itself result in larger residual frequency errors (ΔF_{UE}) and degrade the UE demodulation performance.

The following approach is proposed to solve the problem:

The network (gNB) provides UE information that it operates in the single tap HST scenario (i.e. provides network assistance): higher-layer signaling can be used to inform the UE (e.g., RRC signaling); the signaling can be provided in either broadcast (cell-specific) or UE-specific manner; the signaling may include the following information—a general indication that UE operates in a single tap HST conditions, and additional deployment-specific information (e.g., max speed, max expected Doppler shift); the signaling can be provided on a per-carrier basis (i.e. per-cell), the separate indication can be provided for different TCI states, or separate indication can be provided for different TRS (CSI-RS for tracking).

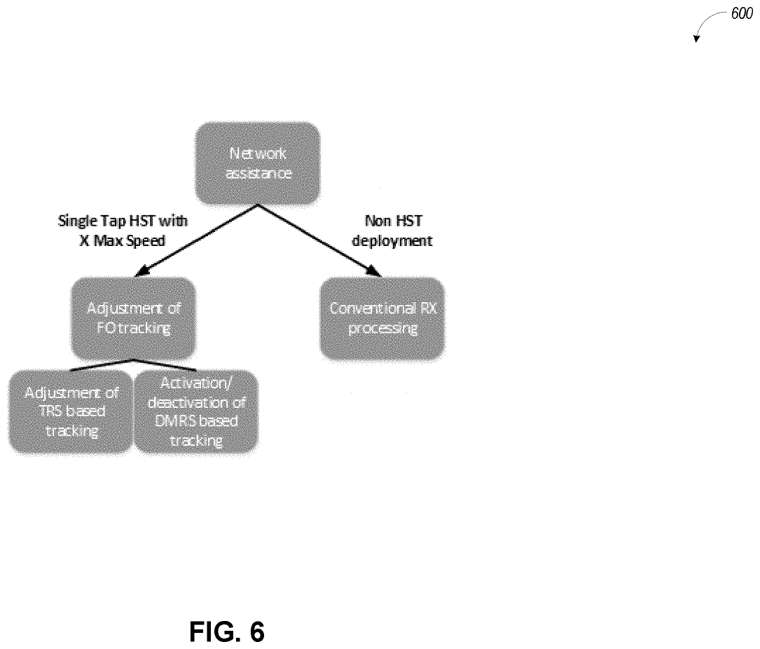

The UE may adjust its RX behavior upon reception of the corresponding network assistance. In some aspects, the TRS-based FO tracking algorithm may be adjusted to minimize the averaging/filtering granularity. For example, the UE can use single-shot FO estimation and avoid averaging across multiple TRS occasions. In some aspects, the UE can activate and deactivate PDSCH DMRS for FO tracking under certain conditions. For example, for scenarios with low or medium train speed (i.e. up to 200-300 km/h), TRS-based FO tracking may be sufficient and UE may deactivate PDSCH DMRS tracking to save power. FIG. 6 illustrates a diagram 600 of network assistance and UE behavior, in an example embodiment.

### Embodiment #2: NB-Based Control of UE TX/RX Frequency

The embodiment #2 is aimed to solve Issue #2 described hereinabove. Another technical issue associated with NR operation in the single tap HST deployment is related to UL frequency offset handling at the gNB side. In single tap deployments, the UE is expected to adjust its TX frequency to the effective receive signal frequency which includes the Doppler shift (FDoppler). Therefore, at the gNB RX side, the total frequency offset may increase significantly and can exceed 2× FDoppler frequency. Under high-speed propagation conditions, the total FO can be high enough and may not be efficiently handled. For instance, the FO can exceed the max FO, which can be estimated using DMRS. Also, even if the FO can be estimated, the gNB may still apply post-FFT FO compensation approach, and in the latter case, the FO may cause large inter-carrier interference (ICI) which will have an impact on the demodulation performance. Therefore, additional solutions to reduce the total residual FO at the gNB side may be used.

The following approach is proposed to solve the issue:

The network (gNB) provides UE information/commands to adjust the UE UL transmission frequency to minimize the UL RX signal frequency offset.

Signaling Details.

The gNB provides signaling to the UE to command it to adjust (increase/reduce) the TX carrier frequency relative to the existing level. In some aspects, dynamic signaling can be provided. For example, additional fields can be added to the DCI. Signaling on operation in single tap HST deployment, described in embodiment #1, can be used to inform UE on additional bits in DCI.

A list of potential values for UE TX frequency adjustment can be higher-layer configured or pre-defined. This list may be defined to ensure that it covers the highest frequency offset value, specific for a certain scenario, and with sufficient granularity to provide rather accurate TX frequency adjustment.

In some aspects, DCI can contain the pointer to value contained in the list of potential values for UE TX frequency adjustment.

UE Behavior.

Upon reception of the gNB command, the UE may adjust the TX signal frequency by the required amount. The adjustment on UL transmission frequency can be done by one of the following ways. Option 1: In RF (i.e., LO adjustment). Option 2: In baseband (e.g., introduce frequency shift in the TX signal).

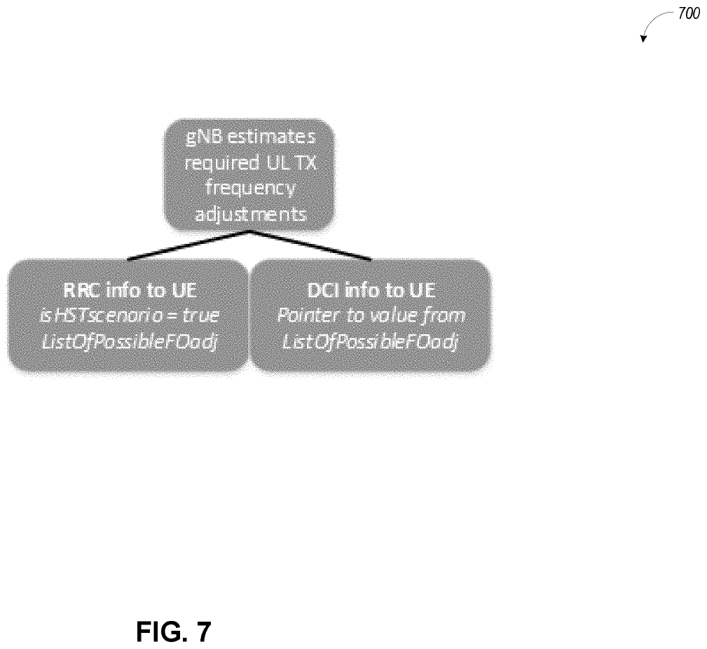

In some aspects, to decide on the required level of TX frequency adjustment at the UE, the gNB performs measurements of the UL receive signal frequency offset. The general principle used at the gNB side could be to minimize the UL signal RX frequency error. FIG. 7 illustrates a diagram 700 of gNB signaling to adjust the UE uplink (UL) transmission frequency, in an example embodiment.

In some aspects, a method of network assistance for single tap HST scenarios is provided. In some aspects, the network (gNB) provides UE information that it operates in the single tap HST scenario. In some aspects, higher-layer signaling can be used. In some aspects, the signaling can be provided in either broadcast (cell-specific) or UE-specific manner. In some aspects, the signaling may include a general indication that UE operates in a single tap HST conditions. In some aspects, the signaling may include additional deployment-specific information (e.g. max speed, max expected Doppler shift). In some aspects, the signaling can be provided on a per-carrier basis (i.e. per-cell). In some aspects, separate indications can be provided for different TCI states. In some aspects, a separate indication can be provided for different TRS (CSI-RS for tracking). In some aspects, the UE may adjust its RX behavior upon reception of the corresponding network assistance. In some aspects, the UE may adjust the TRS-based FO tracking algorithm. In some aspects, the UE may activate and deactivate the PDSCH DMRS for FO tracking.

In some aspects, gNB-based control of UE TX/RX frequency is provided. In some aspects, the network (gNB) provides UE information/commands to adjust the UE UL transmission frequency. In some aspects, dynamic signaling (i.e., DCI-based) can be provided. In some aspects, signaling on operation in single tap HST deployment may be used to inform the UE on additional bits in DCI. In some aspects, the list of potential values for UE TX frequency adjustment can be higher-layer configured or pre-defined. In some aspects, the DCI can contain the pointer to value contained in the list of potential values for UE TX frequency adjustment. In some aspects, the UE may adjust the TX signal frequency by the required amount. In some aspects, the frequency adjustment can be done in RF. In some aspects, the frequency adjustment can be done in the baseband.

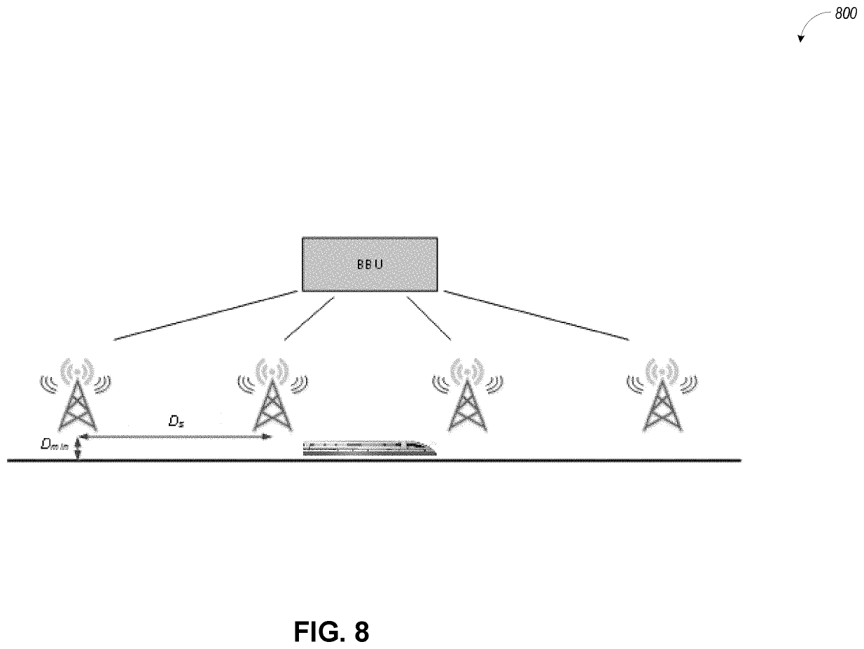

FIG. 8 illustrates a diagram 800 of LTE multi-RRH HST-SFN deployment, in an example embodiment. Techniques disclosed herein can be used in connection with multi-RRH HST deployments. In such deployments, the UE is connected to a single base station (gNB or eNB), which includes multiple remote radio heads (RRHs) (units responsible for RF signals transmission or reception) deployed along the railways (as illustrated in FIG. 8). Multiple RRHs are connected to a single BBU (baseband unit) and share the same cell ID. Typically, RRHs have a fiber connection to the BBU.

In an example embodiment, all RRHs are transmitting the same DL signals simultaneously in a single frequency network (SFN) manner. Such SFN multi-RRH HST deployments are also known as HST SFN deployments and were extensively studied as a part of LTE Rel-13/14 LTE HST SI and WI and an ongoing Rel-16 LTE HST WI. The HST SFN deployments may be used to resolve inter-cell radio resource management (RRM) issues, which may happen due to frequent handover (HO) between the neighboring cells in non-SFN deployments and ensure seamless coverage across multiple RRHs.

In some aspects, the HST deployments may be characterized using the following parameters: the number of RRHs per BBU, the RRH to RRH distance (DS), and RRH to railway track distance (Dmin). The main parameters of these deployments provided by operators are summarized in Table 4.

TABLE 4

| Scenario/Parameters | Description | D_{S} | Dₘᵢₙ |
|---|---|---|---|
| Open Space | 2 or 4 RRHs | 1000 m | 50 m |
| | connect to 1 BBU | | |
| Tunnel | 2 or 4 RRHs | 500 m | 5 m |
| | connect to 1 BBU | | |

For LTE technology, initial studies were conducted in the scope of Rel-14 LTE HST SI and summarized in the TR 36.878. In some aspects, DL demodulation performance degrades under the assumption of using conventional RX processing and therefore multiple enhancements may be considered to improve DL operation:

Advanced Receiver: In the SFN scenario with the omnidirectional antenna (or alike) or separate antennas covering one of two directions per site, the relative powers of two taps of the received signal are comparable, and the Doppler frequencies for them are very high and with the opposite signs, when UE is located around in the middle of two RRHs. The significant downlink performance degradation is observed for the legacy UE, which can only track the single Doppler shift and may assume Jake's spectrum for Doppler spread, because of the imperfect frequency tracking and channel estimation. To meet the challenge, the potential solution is to improve the UE performance algorithm under the SFN. The advanced receiver assumes the existence of multiple Doppler shifts and can estimate them by utilizing the enhanced algorithms. The advanced receiver can properly track the frequency to adjust its oscillator to keep synchronization by assuming the existence of multiple Doppler shifts. The advanced receiver can conduct the proper interpolation for the channel estimation especially in the time domain.

BS frequency pre-compensation: In this solution, the BS may determine the downlink Doppler frequency to be compensated by estimating the uplink Doppler frequency using the uplink signal, e.g., PUCCH and PUSCH, and then compensate the frequency per RRH before transmitting in the downlink.

Unidirectional SFN deployment: The Unidirectional SFN scenario is based on a network deployment where directional antennas are used and where it therefore can be controlled at which point a UE leaves one beam and enters the next. The intention is to provide a stable downlink carrier frequency as experienced by the UE when traveling at high speed. This can be achieved by arranging the RRHs in such a manner that the strongest signal received by the UE has a nearly constant Doppler shift without sign-alternation. A stable downlink frequency as experienced by the UE leads to that uplink transmissions from the same UE are received by the RRHs with a nearly constant frequency offset. Additionally, all UEs traveling onboard the same train share the same Doppler and frequency offset characteristics.

HST RRH with distributed orthogonal antenna ports: Alternative solution to improve UE demodulation performance in the HST SFN deployments is to use a combination of the SFN data signal (e.g. PDSCH) transmissions from different RRHs and orthogonal non-SFN reference signal transmission from different RRHs on orthogonal antenna ports (Distributed Orthogonal Antenna Ports). An HST-enhanced UE (HeUE) may estimate the propagation channel and channel statistics including power delay profile, frequency, and time offsets for each RRH separately using the reference signal and use this information to improve the demodulation of the combined SFN data signal.

In Rel-16 NR HST WI, the maximum considered Doppler frequency is expected to be limited by 1666 Hz which corresponds to the 3.6 GHz carrier frequency and 500 km/h train speed. Several techniques are disclosed herein to enable NR operation in multi-RRH HST SFN and non-SFN deployments.

The proposed solutions have the following benefits:

### Embodiment #1

Adaptive selection of SFN and non-SFN transmission modes may improve the flexibility and performance of NR HST networks.

### Embodiment #2

UE can adjust the receiver algorithm to improve DL performance in case it is aware of specific propagation conditions due to HST deployment. The proposed network assistance allows an indication of the presence of HST-SFN conditions for each DL beam (TCI state) and hence allows joint operation of SFN and non-SFN in HST networks.

### Embodiment #3

Proposed non-SFN DMRS transmission allows UE to improve channel estimation accuracy and substantially improved demodulation performance under high-speed SFN propagation conditions.

### Embodiment #1: Simultaneous Support of SFN and Non-SFN Operation in HST Multi-RRH Networks

One of the issues addressed via using SFN mode (i.e., simultaneous transmission of same DL signals from different RRHs) in LTE HST deployments is radio link failure (RLF) due to fast change of the serving cell and frequent handover (HO) between the cells. Such SFN transmission may be challenging from the UE demodulation performance perspective and multiple enhancements may be considered to avoid performance degradation.

NR systems naturally support multi-beam operation, which well-suits target multi-RRH deployments connected to a single BBU and sharing the same cell ID. For instance, multiple RRHs may share the same cell ID but at the same time, the DL signals are not required to be transmitted in an SFN manner. Different RRHs can be assigned to represent different beams and a regular NR beam management approach can be adopted. For instance, different RRHs can be assigned to operate using different SS block resources/positions. Alternatively, the SS/PBCH transmission can be done in an SFN manner with a single SS block position, while the CSI-RS based beam management can be used with different CSI-RS assigned for transmission from different RRHs. The PDSCH can be transmitted in a non-SFN manner using RRH corresponding to the best DL beam.

In some aspects, in a general case, it may be beneficial for the HST network to be able to operate in both an SFN or non-SFN manner simultaneously. For instance, for some UEs SFN transmission can be beneficial, while non-SFN transmission can be beneficial for other UEs. NR supports the general framework to allow such operation.

The following framework is considered for the HST networks including both SFN and non-SFN operation:

The gNB includes a BBU and N (N>1) RRHs deployed along the railways.

The gNB can support both SFN and non-SFN transmissions: Non-SFN transmissions are made from individual RRHs (i.e. each RRH transmits individual DL signals), and SFN transmissions come from several RRHs (i.e. subset of RRHs transmit same DL signals simultaneously).

The SFN and non-SFN transmissions can be associated with different TCI states (i.e. treated as different DL beams, associated with different DL signals and RSs and have different QCL assumptions).

The gNB adaptively chooses SFN or non-SFN modes for each UE or a subset of UEs operating in the network.

The gNB can configure CSI-RS resources (e.g. CSI-RS for tracking, for CSI-RS for CSI acquisition, CSI-RS for L1-RSRP computation, etc) corresponding to SFN and non-SFN transmissions.

In some aspects, the UE may perform tracking of channel parameters (incl. frequency offset, time offset, Doppler spread, Delay spread, etc) for non-SFN and SFN transmissions. For example, TRS (CSI-RS for tracking) associated with each type of transmission may be used.

In some aspects, the UE may perform measurements (e.g. RSRP measurement, CSI measurements) under SFN and non-SFN transmission hypothesis and report back to the gNB.

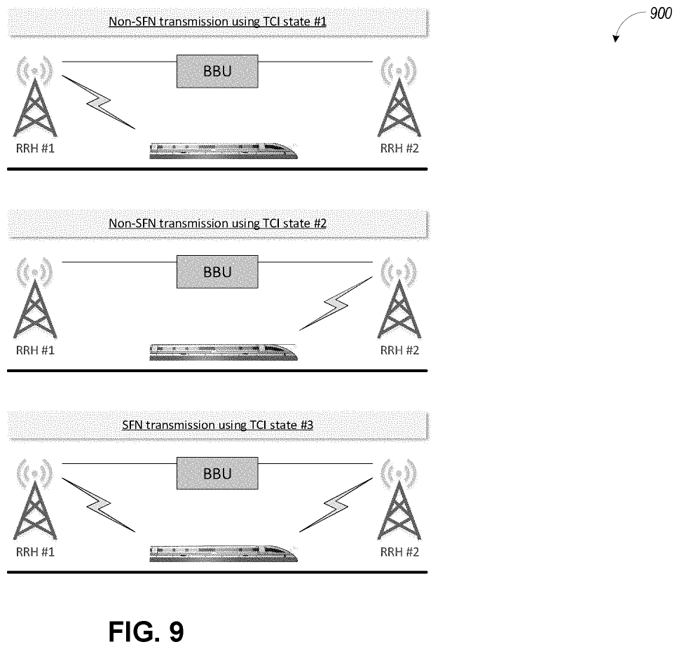

An example network is illustrated in FIG. 9. FIG. 9 illustrates a diagram 900 of SFN and non-SFN transmissions associated with different TCI states, in an example embodiment. In some aspects, the gNB comprises of 2 RRHs connecting to a BBU. In some aspects, the gNB can support both SFN and non-SFN transmissions: Non-SFN transmissions are made from individual RRHs 1 and 2; and SFN transmissions may be done via joint transmissions from RRHs 1 and 2.

In some aspects, the SFN and non-SFN transmissions can be associated with different TCI states. TCI state 1 is associated with DL signals transmitted in a non-SFN manner from RRH1. TCI state 2 is associated with DL signals transmitted in a non-SFN manner from RRH2. TCI state 3 is associated with DL signals transmitted in an SFN manner from RRH1 and RRH2

In some aspects, in a general case, the networks comprising the SFN and non-SFN transmissions can be implemented using conventional NR mechanisms via proper configuration. Specific enhancements to improve UE operation under HST SFN scenarios in such type of networks include:

Channel tracking enhancements: the UE may perform tracking of channel parameters (incl. frequency offset, time offset, Doppler spread, Delay spread, etc.) for non-SFN transmissions and use the estimates to the SFN transmission parameters. For example, the above UE may track the parameters of propagation conditions from each RRH using RSs associated with TCI State 1 and 2 to derive the parameters for the combined channel corresponding to the SFN transmission.

Signaling enhancements: described in embodiment #2.

### Embodiment #2: Network Assistance for HST-SFN Scenarios

In HST SFN scenarios the DL channel propagation conditions become very specific and conventional UE receiver channel estimation and frequency tracking algorithms may not achieve good performance. To improve the performance UE may be required to adjust the channel estimation and frequency offset tracking algorithms (i.e., apply enhanced receive processing algorithms). In LTE, the UE is provided with dedicated network assistance to inform the UE that it is located under HST-SFN deployment such that it can improve the demodulation performance. A similar approach can be used in NR with several improvements on top of the existing LTE signaling. For instance, the signaling may be designed in a way to enable simultaneous support of SFN and non-SFN modes in the same network.

In some aspects, the following network assistance framework may be used.

In some aspects, the network (gNB/eNB) may provide the UE information that HST-SFN propagation conditions may exist (e.g., the UE operates in HST-SFN deployments).

In some aspects, the following signaling types may be used: higher-layer RRC signaling can be used, or dynamic signaling (e.g., DCI-based signaling) can be used alternatively in case it is expected that SFN conditions may change dynamically.

In some aspects, the following HST-SFN specific conditions information can be provided:

(a) information that UE is located in HST-SFN deployment (i.e., that there are multiple RRHs deployed across the railways and RRHs are transmitting DL signals in SFN manner). The information can be provided in a form of flag or indicator of SFN conditions.

(b) information on the max speed (range of speeds) supported in the current HST-SFN deployment. In the latter case, the UE may adjust the RX algorithms for the particular maximum speed.

In one embodiment, the signaling can be provided on a per Cell basis and applicable to all DL transmissions in the cell.

Alternatively, in another embodiment, to enable joint support of SFN and non-SFN operation, the network can provide the signaling in a way that UE can differentiate whether the particular scheduled DL signals associated with a certain TCI state (CSI-RS, TRS, DMRS, PDSCH, etc.) are transmitted in SFN or non-SFN manner. In this scenario, it may be assumed the framework described in Embodiment #1 and that gNB may support both SFN and non-SFN operation (e.g., associated with different TCI states).

In some aspects, the signaling may provide information on the DL signals associated with HST-SFN transmissions. The provided information may apply to all or a subset of configured DL signals.

Option 1: In some aspects, the signaling can be provided as a part of the TRS (CSI-RS for tracking) configuration. For example, the UE can be informed whether SFN or conventional (non-SFN) conditions apply for each particular TRS (CSI-RS for tracking).

Option 2: In some aspects, the signaling can be provided as a part of the TCI state configuration. For example, UE can be informed whether SFN or conventional (non-SFN) conditions apply for reference signals associated with each particular TCI state.

Option 3: In some aspects, separate signaling with a list of TCI states or TRS corresponding to HST-SFN conditions can be provided. In some aspects, other signaling methods may be used as well.

In some aspects, the signaling may include the mapping between the SFN and non-SFN transmissions from the gNB. The main idea is to allow the UE to derive the mapping between SFN and non-SFN transmissions. For instance, if the UE is provided with such information, then it can use the TRS (CSI-RS for tracking) associated with non-SFN transmissions to estimate the parameters of the SFN transmissions (e.g. use for FO tracking, delay spread, Doppler spread, time offset estimation, etc.). In some aspects, one TRS associated with the SFN transmission may comprise 2 or more non-SFN TRS, and information on the mapping between the SFN and non-SFN TRS can be beneficial. In some aspects, one TCI state associated with an SFN transmission may comprise 2 or more non-SFN TCI states, and information on the mapping between the SFN and non-SFN TCI states can be beneficial.

In some aspects, the system may include 3 TCI states. For example, the gNB comprises of 2 RRHs. TCI state 1 is associated with TRS #1 transmitted in a non-SFN manner from RRH1. TCI state 2 is associated with TRS #2 transmitted in a non-SFN manner from RRH2. TCI state 3 is associated with TRS #3 transmitted in SFN manner from RRH1 and RRH2. In some aspects, the gNB may inform UE that TCI state 3 and/or associated TRS has HST-SFN conditions, and propagation conditions for TCI state 3 and associated TRS correspond to propagation conditions in case of SFN transmission of TRSs associated with TCI state 1 and 2.

In some aspects, the information can be also provided on a per-CC basis or for a set of supported CCs.

### #3: Non-SFN Reference Signal Transmission in HST-SFN Networks

In some aspects, an alternative solution to improve UE demodulation performance in NR HST SFN deployments is to adopt principles of distributed orthogonal antenna ports solution.

In some aspects, the approach may include the use of a combination of the SFN data signal (e.g., PDSCH) transmissions from different RRHs and orthogonal non-SFN reference signals transmitted from different RRHs. In this case, the propagation channel and channel statistics including power delay profile, frequency and time offsets for each RRH may be estimated separately using the reference signal and use this information to improve the demodulation of the combined SFN data signal.

An outline of the general principles of the approach and aspects specific to NR design are provided.

Deployment

In some aspects, the gNB includes a BBU and N (N>1) RRHs deployed along the railways. In some aspects, the gNB can support both SFN and non-SFN transmissions. In some aspects, SFN transmissions come from several RRHs (an SFN RRH group). In some aspects, non-SFN transmissions are made from individual RRHs. In some aspects, the SFN transmission includes the joint transmission of the same DL signals from more than one RRH.

DL Signal Transmission

In some aspects, NR PDSCH transmissions are done in SFN manner.

In some aspects, NR PDSCH DMRS transmissions corresponding to SFN PDSCH can be done in a non-SFN manner. In some aspects, the SFN RRH group is divided into subsets and each RRH subsets uses individual DMRS signals. In case each subset includes 1 RRH, then each RRH transmits individual DMRS signals. In some aspects, DMRS can be transmitted in an orthogonal manner from different RRHs (an NR-specific solution).

Option 1: Different DMRS antenna ports are used for transmission from different RRHs.

Option 2: Different DMRS sequences are assigned for transmission of signals from different RRHs.

Option 3: DMRS can be transmitted using the same port and sequence. In this case, the set of REs corresponding to the DMRS can be divided between different RRHs (e.g. different symbols assigned for different RRHs, different REs assigned for different RRHs).

In some aspects, other approaches are possible under the assumption that UE is capable to perform separate channel estimation for DMRS coming from each RRH individually.

In some aspects, NR TRS (i.e. CSI-RS for tracking) transmission can be done in a non-SFN manner as well (NR specific aspect). In some aspects, the SFN RRH group is divided into subsets and each RRH subsets uses individual TRS signals. In case each subset includes 1 RRH, then each RRH transmits individual TRS signals. Also, a combined SFN TRS signal can be transmitted.

In some aspects, other NR signals (e.g., CSI-RS) can be transmitted in a non-SFN manner

Network Assistance

In some aspects, the gNB shall inform UE on the presence of HST-SFN deployment with non-SFN reference signal transmission.

In some aspects, signaling types can include higher layer signaling (e.g., RRC) or dynamic signaling (DCI-based). In some aspects, the signaling may further include a general indication of HST-SFN deployment with non-SFN reference signal transmission. In some aspects, an indication of the set non-SFN DMRS may be used for demodulation SFN PDSCH transmission. For example, signaling may be used to indicate the set of non-SFN DMRS APs which correspond to SFN PDSCH. In some aspects, signaling may be used to indicate the set of non-SFN DMRS sequences that correspond to SFN PDSCH.

UE Behavior

In some aspects, the UE receives a superposition of DMRS signals from different RRHs. The receiver can demodulate the RS for each AP/sequence corresponding to different RRH following the legacy RS demodulation procedure. Channel parameters for signals from different RRHs can be separately estimated using the demodulated DMRS per each AP.

In some aspects, different approaches for the PDSCH signal demodulation can be considered. Option 1: A basic receiver strategy is IRC, which means that the receiver utilizes the strong power channel link for the data signal demodulation and suppresses the other link signals as interference. Option 2: To improve the performance, the receiver can combine the multiple layer signals from SFN RRH. The receiver can perform the MIMO demodulation processing under the assumption of a multi-layer RX signal (e.g. MMSE). Then, it can combine the demodulated signals from different MIMO layers (RRHs). Option 3: The receiver can use the estimates of the channels from each RRH to estimate the combined SFN channel and then perform conventional RX processing of the combined receive signal.

In some aspects, the UE can use TRS signal transmission from different RRHs to estimate the channel characteristics (e.g. Doppler shift, frequency offset, timing offset, power delay profile, delay spread, Doppler spread) for each RRH. The obtained estimates can be further used as a part of channel estimation and demodulation of SFN signals coming from a combination of RRHs.

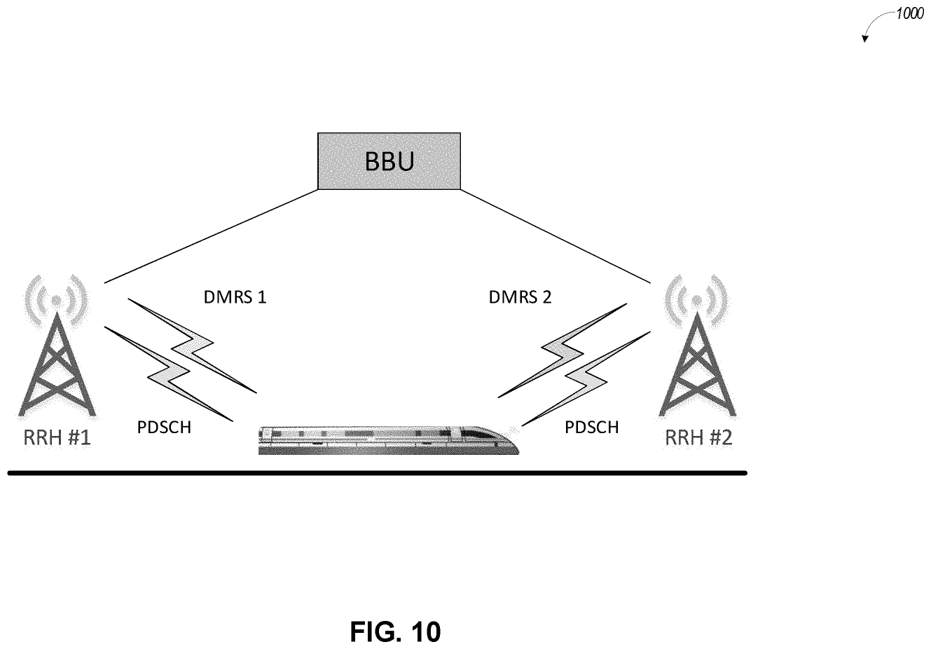

An example illustration of the non-SFN RS concept is provided in FIG. 10. FIG. 10 illustrates a diagram 1000 of non-SFN reference signal (RS) transmissions, in an example embodiment. The gNB comprises of 2 RRHs connecting to a BBU, and the NR PDSCH transmissions are done in SFN manner from RRH1 and RRH2. The NR PDSCH DMRS transmissions corresponding to SFN PDSCH are done in a non-SFN manner with one DMRS transmission from RRH1 and separate DMRS transmission from the 2nd RRH.

A method of simultaneous support of SFN and non-SFN operation in HST multi-RRH networks is disclosed. In some aspects, the gNB can support both SFN and non-SFN transmissions. In some aspects, the SFN and non-SFN transmissions can be associated with different TCI states. In some aspects, the gNB adaptively chooses SFN or non-SFN modes for each UE or a subset of UEs operating in the network. In some aspects, the gNB can configure CSI-RS resources (e.g. CSI-RS for tracking, for CSI-RS for CSI acquisition, CSI-RS for L1-RSRP computation, etc.) corresponding to SFN and non-SFN transmissions. In some aspects, the UE may perform tracking of channel parameters (including frequency offset, time offset, Doppler spread, Delay spread, etc.) for non-SFN and SFN transmissions. In some aspects, the UE may perform measurements (e.g. RSRP measurement, CSI measurements) under SFN and non-SFN transmission hypothesis and report back to the gNB.

In some aspects, a method of network assistance for HST-SFN scenarios is disclosed. In some aspects, the network (gNB/eNB) provides the UE information that HST-SFN propagation conditions may exist (e.g., info that the UE operates in HST-SFN deployments). In some aspects, higher-layer RRC signaling can be used. In some aspects, dynamic signaling can be used. In some aspects, the signaling contains information that UE is located in HST-SFN deployment. In some aspects, the signaling contains information on the max speed (range of speeds) supported in the current HST-SFN deployment. In some aspects, the network can provide the signaling in a way that UE can differentiate whether the particular scheduled DL signals (TRS, DMRS, PDSCH, etc.) are transmitted in SFN or non-SFN manner. In some aspects, the signaling may provide information on the DL signals associated with HST-SFN transmissions. In some aspects, the signaling can be provided as a part of the TRS (CSI-RS for tracking) configuration. In some aspects, the signaling can be provided as a part of the TCI state configuration. In some aspects, the signaling contains a list of TCI states or TRS corresponding to HST-SFN conditions that can be provided. In some aspects, other signaling methods are possible. The signaling may include the mapping between the SFN and non-SFN transmissions from the gNB.

In some aspects, a method of support of non-SFN reference signal transmission in HST-SFN networks is disclosed. In some aspects, the DL signal transmission is modified. In some aspects, NR PDSCH transmissions are done in SFN manner. In some aspects, NR PDSCH DMRS transmissions corresponding to SFN PDSCH can be done in a non-SFN manner. In some aspects, the SFN RRH group is divided into subsets and each RRH subsets uses individual DMRS signals. In some aspects, DMRS can be transmitted in an orthogonal manner from different RRHs. In some aspects, different DMRS antenna ports are used for transmission from different RRHs. In some aspects, different DMRS sequences are assigned for transmission of signals from different RRHs. In some aspects, DMRS can be transmitted using the same port/sequence and the set of REs corresponding to the DMRS can be divided between different RRHs.

In some aspects, other approaches are possible under the assumption that UE is capable to perform separate channel estimation for DMRS coming from each RRH individually. In some aspects, the NR TRS (i.e. CSI-RS for tracking) transmission can be done in a non-SFN manner as well (NR specific aspect). In some aspects, other NR signals (e.g. CSI-RS) can be transmitted in a non-SFN manner. In some aspects, the gNB may inform the UE of the presence of HST-SFN deployment with Non-SFN reference signal transmission. In some aspects, higher layer signaling can be used. In some aspects, dynamic signaling can be used. In some aspects, the signaling may include a general indication of HST-SFN deployment with Non-SFN reference signal transmission. In some aspects, the signaling may include an indication of the set non-SFN DMRS to be used for demodulation SFN PDSCH transmission. In some aspects, the UE behavior can be adjusted. In some aspects, the receiver can demodulate the RS for each AP/sequence corresponding to different RRH following the legacy RS demodulation procedure. In some aspects, different approaches for the PDSCH signal demodulation can be considered.

In some aspects, a basic receiver strategy is IRC. In some aspects, a receiver can combine the multiple layer signals from SFN RRH. In some aspects, the receiver can use the estimates of the channels from each RRH to estimate the combined SFN channel and then perform conventional RX processing of the combined receive signal. In some aspects, the UE can use TRS signal transmission from different RRHs to estimate the channel characteristics (e.g. Doppler shift, frequency offset, timing offset, power delay profile, delay spread, Doppler spread) for each RRH.

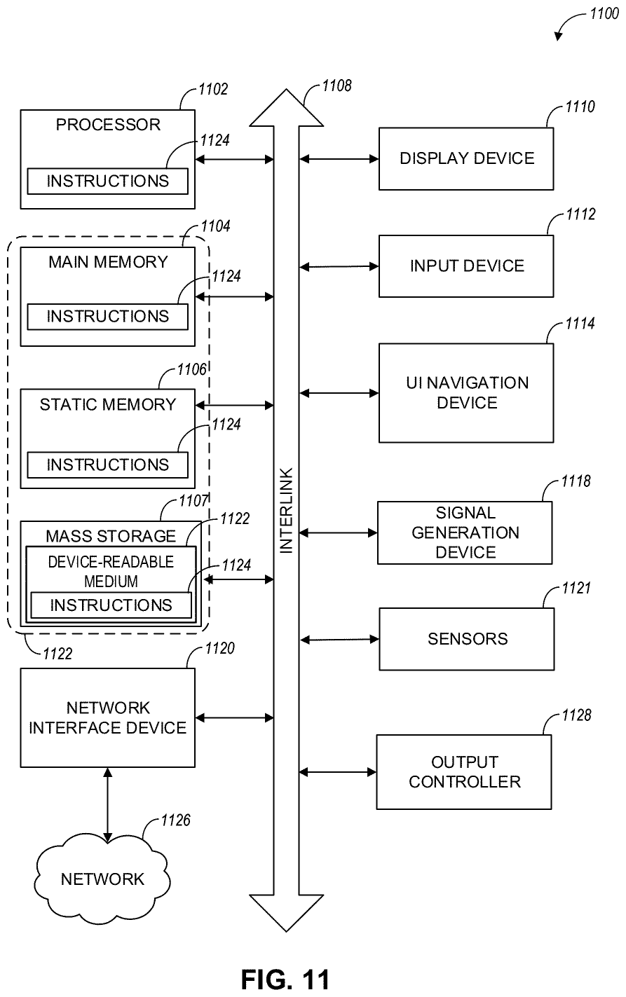

FIG. 11 illustrates a block diagram of a communication device such as an evolved Node-B (eNB), a next generation Node-B (gNB), an access point (AP), a wireless station (STA), a mobile station (MS), or user equipment (UE), in accordance with some aspects and to perform one or more of the techniques disclosed herein. In alternative aspects, the communication device 1100 may operate as a standalone device or may be connected (e.g., networked) to other communication devices.

Circuitry (e.g., processing circuitry) is a collection of circuits implemented in tangible entities of the device 1100 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 1100 follow.

In some aspects, the device 1100 may operate as a standalone device or may be connected (e.g., networked) to other devices. In a networked deployment, the communication device 1100 may operate in the capacity of a server communication device, a client communication device, or both in server-client network environments. In an example, the communication device 1100 may act as a peer communication device in peer-to-peer (P2P) (or other distributed) network environment. The communication device 1100 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1100 may include a hardware processor 1102 (e.g., a central processing unit (CPU), a graphics processing unit (GPU), a hardware processor core, or any combination thereof), a main memory 1104, a static memory 1106, and mass storage 1107 (e.g., hard drive, tape drive, flash storage, or other block or storage devices), some or all of which may communicate with each other via an interlink (e.g., bus) 1108.

The communication device 1100 may further include a display device 1110, an alphanumeric input device 1112 (e.g., a keyboard), and a user interface (UI) navigation device 1114 (e.g., a mouse). In an example, the display device 1110, input device 1112, and UI navigation device 1114 may be a touchscreen display. The communication device 1100 may additionally include a signal generation device 1118 (e.g., a speaker), a network interface device 1120, and one or more sensors 1121, such as a global positioning system (GPS) sensor, compass, accelerometer, or another sensor. The communication device 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1107 may include a communication device-readable medium 1122, on which is stored one or more sets of data structures or instructions 1124 (e.g., software) embodying or utilized by any one or more of the techniques or functions described herein. In some aspects, registers of the processor 1102, the main memory 1104, the static memory 1106, and/or the mass storage 1107 may be, or include (completely or at least partially), the device-readable medium 1122, on which is stored the one or more sets of data structures or instructions 1124, embodying or utilized by any one or more of the techniques or functions described herein. In an example, one or any combination of the hardware processor 1102, the main memory 1104, the static memory 1106, or the mass storage 1116 may constitute the device-readable medium 1122.

As used herein, the term “device-readable medium” is interchangeable with “computer-readable medium” or “machine-readable medium”. While the communication device-readable medium 1122 is illustrated as a single medium, the term “communication device-readable medium” may include a single medium or multiple media (e.g., a centralized or distributed database, and/or associated caches and servers) configured to store the one or more instructions 1124. The term “communication device-readable medium” is inclusive of the terms “machine-readable medium” or “computer-readable medium”, and may include any medium that is capable of storing, encoding, or carrying instructions (e.g., instructions 1124) for execution by the communication device 1100 and that causes the communication device 1100 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 1124 may further be transmitted or received over a communications network 1126 using a transmission medium via the network interface device 1120 utilizing any one of a number of transfer protocols. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input-multiple-output (SIMO), MIMO, or multiple-input-single-output (MISO) techniques. In some examples, the network interface device 1120 may wirelessly communicate using Multiple User MIMO techniques.

The term “transmission medium” shall be taken to include any intangible medium that is capable of storing, encoding or carrying instructions for execution by the communication device 1100, and includes digital or analog communications signals or another intangible medium to facilitate communication of such software. In this regard, a transmission medium in the context of this disclosure is a device-readable medium.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus to be used in a user equipment (UE), the apparatus comprising:
processing circuitry, wherein to configure the UE for high-speed train (HST) communications in a 5G-New Radio (NR) network, the processing circuitry is to:
decode configuration signaling received from a remote radio head (RRH) operating as a next generation Node-B (gNB), the configuration signaling indicating an upcoming configuration transmission of network assistance information from the RRH;
decode the network assistance information received from the RRH during the configuration transmission;
perform a tracking reference signal (TRS)-based processing to track a frequency offset (FO) associated with a downlink data transmission from the RRH, the TRS-based processing using a single-shot FO estimation based on a FO instruction in the network assistance information received from the RRH; and
demodulate the downlink data transmission based on applying a local oscillator (LO) adjustment using the FO; and
a memory coupled to the processing circuitry and configured to store the network assistance information.

2. The apparatus of claim 1, wherein the configuration signaling indicates that the UE and the RRH operate in a single tap HST deployment with network assistance, and wherein the configuration transmission with the network assistance information is a non-single frequency network (non-SFN) transmission from the RRH.

3. The apparatus of claim 2, wherein the configuration signaling is radio resource control (RRC) signaling including deployment-specific information associated with the single tap HST deployment.

4. The apparatus of claim 3, wherein the processing circuitry is further to:
demodulate the downlink data transmission further based on the deployment-specific information.

5. The apparatus of claim 3, wherein the deployment-specific information includes a maximum expected Doppler shift for the HST deployment.

6. The apparatus of claim 1, wherein the configuration signaling is associated with a cell of the RRH and a transmission configuration indicator (TCI) state of the configuration transmission from the RRH.

7. The apparatus of claim 1, wherein the processing circuitry is further to:
track the FO associated with the downlink data transmission from the RRH using activation of a physical downlink shared channel (PDSCH) demodulation reference signal (DMRS) based on the network assistance information.

8. The apparatus of claim 1, wherein the processing circuitry is further to:
decode higher layer signaling received from the RRH via a non-single frequency network (SFN) transmission, the higher layer signaling indicating the RRH and the UE are within an HST-SFN deployment.

9. The apparatus of claim 8, wherein the processing circuitry is further to:
decode a physical downlink shared channel (PDSCH) transmission based on the indication of the HST-SFN deployment in the higher layer signaling.

10. The apparatus of claim 1, further comprising transceiver circuitry coupled to the processing circuitry; and, one or more antennas coupled to the transceiver circuitry.

11. A non-transitory computer-readable storage medium that stores instructions for execution by one or more processors of a next generation Node-B (gNB), the instructions to configure the gNB for high-speed train (HST) communications in a 5G-New Radio (NR) network, and to cause the gNB to:
decode an uplink signal received from a user equipment (UE) in a single tap HST deployment;
determine an uplink receive (Rx) signal frequency offset (FO) based on the decoded uplink signal;
encode configuration signaling for transmission to the UE, the configuration signaling including a transmit carrier frequency adjustment command for a transmit circuitry of the UE, the transmit carrier frequency adjustment command based on the determined uplink Rx signal FO.

12. The non-transitory computer-readable storage medium of claim 11, wherein executing the instructions further configures the gNB to:
generate the transmit carrier frequency adjustment command further based on minimizing an Rx frequency error associated with the received uplink signal.

13. The non-transitory computer-readable storage medium of claim 11, wherein the configuration signaling is one of downlink control information (DCI) or radio resource control (RRC) signaling.

14. The non-transitory computer-readable storage medium of claim 11, wherein executing the instructions further configures the gNB to:
encode higher layer signaling for transmission to the UE, the higher layer signaling indicating that the UE is within an HST Single Frequency Network (HST-SFN) deployment associated with a receiver processing algorithm for tracking frequency offset.

15. A non-transitory computer-readable storage medium that stores instructions for execution by one or more processors of a user equipment (UE), the instructions to configure the UE for high-speed train (HST) communications in a 5G-New Radio (NR) network, and to cause the UE to:
decode configuration signaling received from a remote radio head (RRH) operating as a next generation Node-B (gNB), the configuration signaling indicating an upcoming configuration transmission of network assistance information from the RRH;
decode the network assistance information received from the RRH during the configuration transmission;
perform a tracking reference signal (TRS)-based processing to track a frequency offset (FO) associated with a downlink data transmission from the RRH, the TRS-based processing using a single-shot FO estimation based on a FO instruction in the network assistance information received from the RRH; and
demodulate the downlink data transmission based on applying a local oscillator (LO) adjustment using the FO.

16. The non-transitory computer-readable storage medium of claim 15, wherein the configuration signaling indicates that the UE and the RRH operate in a single tap HST deployment with network assistance, wherein the configuration transmission with the network assistance information is a non-single frequency network (non-SFN) transmission from the RRH, and wherein the configuration signaling is radio resource control (RRC) signaling including deployment-specific information associated with the single tap HST deployment.

17. The non-transitory computer-readable storage medium of claim 16, wherein executing the instructions cause the UE to:
demodulate the downlink data transmission further based on the deployment-specific information.

18. The non-transitory computer-readable storage medium of claim 15, wherein the configuration signaling is associated with a cell of the RRH and a transmission configuration indicator (TCI) state of the configuration transmission from the RRH.

19. The non-transitory computer-readable storage medium of claim 15, wherein executing the instructions cause the UE to:
decode higher layer signaling received from the RRH via a non-single frequency network (SFN) transmission, the higher layer signaling indicating the RRH and the UE are within an HST-SFN deployment.

20. The non-transitory computer-readable storage of claim 19, wherein executing the instructions cause the UE to:
decode a physical downlink shared channel (PDSCH) transmission based on the indication of the HST-SFN deployment in the higher layer signaling.
